(19) United States
(12) Patent Application Publication
(10) Pub. No.: US 2011/0126037 A1
(43) Pub. Date: May 26, 2011

(54) POWER SAVING METHOD IN MOBILE COMMUNICATION NETWORK

(76) Inventors: Sung-Geun Jin, Daejeon (KR); Sung Cheol Chang, Doejeon (KR); Won-Ik Kim, Daejeon (KR); Hyun Lee, Daejeon (KR); Chul Sik Yoon, Seoul (KR)

(21) Appl. No.: 13/003,224

(22) PCT Filed: Jul. 3, 2009
(86) PCT No.: PCT/KR2009/003656

§ 371 Date: Jan. 7, 2011

(30) Foreign Application Priority Data
Jul. 8, 2008 (KR) 10-2008-0066098
Apr. 15, 2009 (KR) 10-2009-0032924

(51) Int. Cl. G06F 1/32

(52) U.S. Cl. 713/323

(57) ABSTRACT

Provided is The present invention provides a method to dynamically control the sleep window or the listening window of a sleep mode in order to minimize power consumption of a mobile terminal. The power saving method relates to a method for a transmitter of a communication system that controls data transmission to a listening window and a sleep window to control the sleep window, wherein if the data transmission is generated during the listening window, the transmitter gradually decreases a sleep window subsequent thereto by a predetermined ratio, and to the contrary, if the data transmission is not generated during the listening window, the transmitter gradually increases a sleep window subsequent thereto by a predetermined ratio.

### TECHNICAL FIELD

An exemplary embodiment of the present invention relates to a method for increasing or decreasing a listening window or a sleep window in a power saving mode in order to minimize power consumption in a mobile communication network.

### BACKGROUND ART

A power saving mode that minimizes power consumption of a mobile terminal is supported in a wideband wireless access system including IEEE 802.16e, Wimax, Wibro, etc. In the power saving mode, the operation of the mobile terminal is made by repeating a sleep interval and a listening interval, wherein the length of the sleep interval and the length of the listening interval are determined by values thereof that are different according to characteristics of predetermined traffic in the corresponding mobile terminal. Therefore, the mobile terminal may have a power saving class of various configurations according to the characteristics of the currently predetermined traffic. By way of examples of the power saving class, there may be a power saving class 1 for non-real-time traffic (hereinafter referred to as “class 1”) and a power saving class 2 for real-time traffic (hereinafter referred to as “class 2”).

Class 1 provides that the length of the listening window is constantly maintained but the length of the sleep window is increased by twice than that of the previous sleep window every time. That is, the length of the sleep window includes the listening window, and when the length of the sleep window reaches a predetermined maximum value, the increase of the sleep window is stopped. When data is received in the sleep window, the mobile terminal should receive the data by waiting for the listening window to arrive so it is required to adjust the length of the sleep window to conform to the arrival period of the data. Also, class 1 and class 2 provide that if the listening window is terminated during data transmission, the data transmission is stopped and the corresponding data transmission is performed again when the subsequent listening window arrives. Therefore, when the amount of data to be transmitted exceeds the available resource limit, the data transmission cannot be terminated at one time, causing a problem that the data transmission is significantly delayed.

Also, a case where class 2 for the real-time data transmission is overlapped with class 1 while the non-real-time data transmission is applied may occur. In this case, the operation according to class 1 is limited by class 2, causing a problem that the efficiency of the data transmission is deteriorated.

Meanwhile, the wideband wireless access system uses various techniques in order to control transmission errors. By way of example of the control technique for the transmission errors, there may be forward error correction (FEC), automatic repeat request (ARQ), and hybrid automatic repeat request (HARQ).

Class 1 and class 2 provide that if the listening window is terminated while the transmission errors are controlled by any one of the techniques, the control of the corresponding transmission errors is performed again by waiting for the subsequent listening window to arrive. Therefore, in the case of the ARQ or the HARQ, a problem arises in that if the listening window is terminated even though errors are detected and thus re-transmission is requested, the re-transmission is performed in the subsequent listening window so that the transmission is significantly delayed.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

An exemplary embodiment of the present invention is proposed to solve the problem. An object of the present invention is to minimize power consumption by controlling a plurality of power saving mode classes to not be overlappedly activated.

Another object of an exemplary embodiment of the present invention is to enhance the efficiency of data transmission by variably operating a listening window.

Another object of an exemplary embodiment of the present invention is to minimize power consumption by clarifying the termination of the sleep window or variably operating the sleep window.

Another object of an exemplary embodiment of the present invention is to enhance data transmission efficiency by guaranteeing the normal operation of an error correction mechanism in a power saving mode.

### Solution to Problem

In order to accomplish the objects, an exemplary embodiment of the present invention provides a power saving method of a transmitter in a sleep mode, including monitoring whether data transmission is generated during a listening window, and decreasing a sleep window subsequent to the listening window if the data transmission is generated during the listening window.

Here, if the data transmission is generated during the listening window, the power saving method of the transmitter in the sleep mode may further include reporting the decrease of the sleep window to a receiver. Alternatively, if the data transmission is generated during the listening window, the receiver and the transmitter may automatically decrease the sleep window according to a predetermined rule.

Another embodiment of the present invention provides a power saving method of a transmitter in a sleep mode, including monitoring whether data transmission is generated during a listening window, and increasing a sleep window subsequent to the listening window if the data transmission is not generated during the listening window.

Here, if the data transmission is not generated during the listening window, the power saving method of the transmitter in the sleep mode may further include reporting the increase of the sleep window to a receiver. Alternatively, if the data transmission is not generated during the listening window, the receiver and the transmitter may automatically increase the sleep window according to a predetermined rule.

Also, if the data transmission is generated during a listening window subsequent to the listening window, the power saving method may further include restoring the subsequent sleep window to the sleep window before being increased.

Yet another embodiment of the present invention provides a power saving method of a transmitter in a sleep mode, including confirming whether data transmission is maintained during a listening window for a predetermined interval, and additionally allocating a temporary listening window if the data transmission is maintained.

Also, if the data transmission is terminated, the power saving method of the transmitter in the sleep mode may further include requesting an immediate termination of the temporary listening window to the receiver.

Yet another embodiment of the present invention provides a power saving method of a receiver in a sleep mode, including, if transmission errors are detected from received data, requesting retransmission of the data to a transmitter, and allocating a temporary listening window for the data retransmission.

Before the allocating the temporary listening window, the power saving method of the receiver in the sleep mode may further include requesting allocation of the temporary listening window to the transmitter.

Yet another embodiment of the present invention provides a power saving method of a transmitter that is connected to a first receiver in a first power saving class, including receiving a connection request for data transmission from a second receiver, and if a second power saving class for the connection with the second receiver is different from the first power saving class, operating as the first power saving class for the second receiver.

For the connection with the second receiver, a partial parameter of the first power saving class may be replaced by a parameter of the second power saving class to be operated.

### Advantageous Effects of Invention

According to the embodiments of the present invention, the power saving mode for the real-time service and the power saving mode for the non-real-time service are integrated into one class and operated, making it possible to minimize a negative effect that the respective modes affect each other. Also, the continuing transmission of data can be guaranteed due to variable operation of the listening window, making it possible to enhance the data transmission efficiency. In addition, the listening window and the sleep window can be optimized by clarifying the termination of the sleep window or by variably operating the sleep window, making it possible to minimize power consumption. Further, the error correction mechanism is normally operated even in the power saving mode, making it possible to enhance the data transmission efficiency.

### BRIEF DESCRIPTION OF DRAWINGS

FIG. 1 is a signal flowchart showing an operating method of a sleep mode according to an exemplary embodiment of the present invention.

FIG. 2 is a signal flowchart showing an operating method of a sleep mode according to another exemplary embodiment of the present invention.

FIG. 3 is a signal flowchart showing an operating method of a sleep mode according to still another exemplary embodiment of the present invention.

FIGS. 4 and 5 show examples of allocation of a temporary listening window for each type.

FIGS. 6 and 7 show examples of reallocation of a temporary listening window.

FIG. 8 shows an example of allocation of a temporary listening window in an operation method of a sleep mode according to another exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

In this specification, a mobile terminal (MT) may designate a mobile station (MS), a terminal, a subscriber station (SS), a portable subscriber station (PSS), user equipment (UE), an access terminal (AT), etc., and may include functions of all or a part of a terminal, a mobile terminal, a subscriber station, a portable subscriber station, user equipment, an access terminal, etc.

In this specification, a base station (BS) may represent an access point (AP), a radio access station (RAS), a node B, eNB (Evolved Node-B), a base transceiver station (BTS), a mobile multihop relay (MMR)-BS, and the like. Further, the base station may have the entire or partial function of the access point, the radio access station, the node B, the eNB, the base transceiver station, the MMR-BS, and the like.

Generally, a communication system includes a transmitter and a receiver. Here, the transmitter and the receiver may be a transceiver that serves to perform both a transmission function and a receiving function. In this specification, one side that transmits transmission data is referred to as a transmitter, and the other side that receives the corresponding transmission data is referred to as a receiver.

A wireless mobile communication network provides a power saving mode or a sleep mode in order to solve a problem that power consumption of a mobile terminal unnecessarily occurs when the amount of data to be transmitted is small or a service having characteristics that data periodically arrives is used. Further, in the power saving mode, a power saving class is prescribed in order to control the specific operation of a base station and the mobile terminal.

Class 1, which is a class being subject to best effort (BE) having characteristics of Internet traffic or non-real-time variable rate (nrt-VR) that is a non-real-time traffic in which the data rate is not changed, is defined by including an initial sleep window, a final window base, a final window exponent, a listening window, and a start frame number for a sleep window.

Class 2, which is a class being subject to a real-time variable rate (rt-VR) that is a real-time traffic in which VoIP or data rate is changed, is defined by including an initial sleep window, a listening window, and a start frame number for a sleep window.

Throughout this specification, the first sleep window and the first listening window represent a sleep window and a listening window that successively exist at an optional time point during the entire window in the sleep mode, and the second sleep window and the second listening window represent windows subsequent to the first sleep window and the first listening window.

### Exemplary Embodiment 1

Exemplary Embodiment 1 relates to a method to minimize power consumption due to data delay by enhancing data transmission efficiency by gradually decreasing the length of a sleep window when data transmission is generated during a listening window.

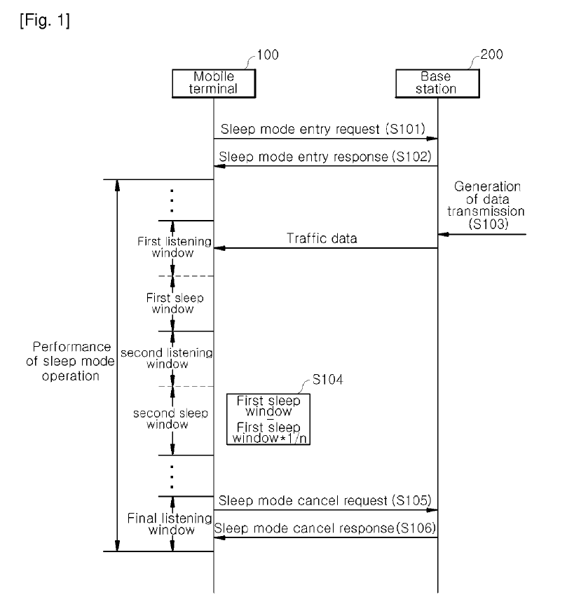

FIG. 1 is a signal flowchart showing an operating method of a sleep mode according to Exemplary Embodiment 1 of the present invention.

If transmission or receipt of data is not generated for a predetermined time, a mobile terminal 100 transmits a predetermined message to a base station 200 to request entry into a sleep mode (S101), and the base station 200 that has received the request transmits a response message to the mobile terminal 100 to enter the sleep mode (S102).

If transmission of data is generated during the first listening window (S103), the mobile terminal 100 decreases the second sleep window by a predetermined ratio (S104). If the data transmission is generated during the sleep window, the data is temporarily stored in a buffer until the subsequent listening window has arrived. The start of the decrease of the sleep window such as step S104 may be limited to not be performed until the first sleep window exceeds the length of the predetermined maximum sleep window.

Specifically, if the transmission or the receipt of data is generated during the first sleep window or the first listening window, the mobile terminal 100 transmits a message to request that the second sleep window is decreased, to the base station 200. To this end, the mobile terminal 100 may include a monitoring device that monitors whether the transmission or the receipt of data is generated during the sleep window or the listening window for a predetermined time. The base station 200 that received the second sleep window decrease request message transmits the response message thereto to the mobile terminal 100 and decreases the second sleep window. The second sleep window decrease request message or the response message to the request may include length information on the decreased second sleep window.

If the data transmission is generated again during the second listening window that is a listening window subsequent to the first listening window, the mobile terminal 100 decreases the third sleep window that is a sleep window subsequent to the second sleep window by a predetermined ratio (not shown in the drawing). If the data transmission is generated during a listening window subsequent to the second listening window, the decrease of the sleep window for sleep windows subsequent to the third sleep window is continued until the sleep mode is terminated. Here, the sleep window may be limited to be decreased within a range that is larger than or equal to a predetermined minimum sleep window.

Meanwhile, the second sleep window and the subsequent sleep window(s) may be decreased at the same ratio or may be decreased at different ratios. By way of example of the latter, the sleep window(s) subsequent to the second sleep window may be decreased at a ratio of (the first sleep window−the first sleep window*1/n), (the first sleep window−the first sleep window*1/n2), the first sleep window*1/n, etc. If a circumstance where the sleep window is decreased is generated successively, this enhances the efficiency of the data transmission by raising the decrease speed of the sleep window to that extent.

If the length of the predetermined sleep window is expired or another termination reason for the sleep mode is generated, the mobile terminal 100 transmits a message requesting that the sleep mode is cancelled to the base station 200 (S105), and the base station 200 that received the request transmits the response message thereto (S106) and deviates from the sleep mode.

The decrease of the sleep window according to Exemplary Embodiment 1 may be made as the mobile terminal 100 determines whether the sleep window is decreased and requests that the sleep window is decreased to the base station 200, and to the contrary, it may also be implemented in the manner that the base station 200 determines whether the sleep window is decreased by checking whether the transmission or the receipt of data is performed and reports the decrease of the sleep window to the mobile terminal 100.

Also, in Exemplary Embodiment 1, if the decrease condition of the sleep window is satisfied, the mobile terminal 100 and the base station 200 may also automatically decrease the sleep window according to a policy that is previously determined. In other words, if the decrease condition of the sleep window is satisfied, the sleep window is decreased under an implied mutual agreement without exchanging separate request and response messages. This will be described in detail.

In the sleep mode, if the transmission or the receipt of data is generated during the first listening window, the mobile terminal 100 and the base station 200 decrease the second sleep window at a ratio according to the predetermined rule therebetween. To this end, the mobile terminal 100 and the base station 200 may include a monitoring device that monitors whether the transmission or the receipt of data is generated during the listening window for a predetermined time.

If the data transmission is generated during the second listening window that is a listening window subsequent to the first listening window, the mobile terminal 100 and the base station 200 decrease the third sleep window that is a sleep window subsequent to the second sleep window by the ratio according to the rule.

Also, if the data transmission is generated during listening windows subsequent to the second listening window, the decrease of the sleep window as described above is repeated for the sleep windows subsequent to the third sleep window until the sleep mode is terminated. The repetition as described above may be performed when the decreased sleep window is larger than the predetermined minimum sleep window.

Meanwhile, if there is no more data to be transmitted to the mobile terminal 100 or the base station 100 as the data transmission is terminated, the termination of the listening window may be requested to the other party. The other party terminates the listening window for the corresponding request and transmits the response message thereto. This may be applied to both cases where the decrease of the sleep window is requested using an explicit message and the decrease of the sleep window is performed impliedly according to the predetermined rule.

### Exemplary Embodiment 2

Exemplary Embodiment 2 relates to a method to minimize power consumption by gradually increasing the length of a sleep window when data transmission is not generated during the listening window of class 1.

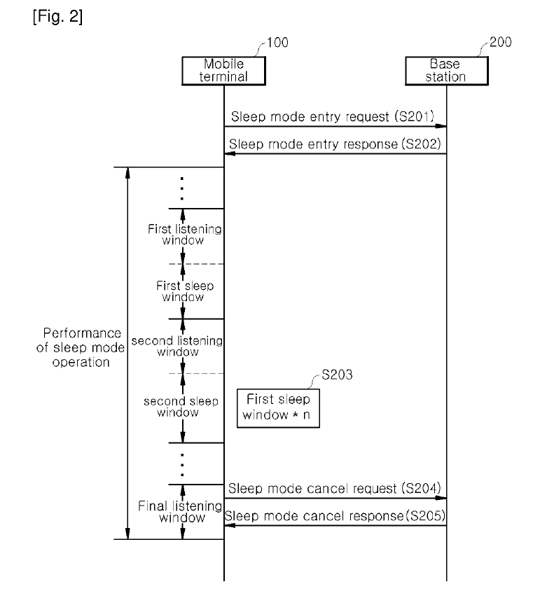

FIG. 2 is a signal flowchart showing an operating method of a sleep mode according to Exemplary Embodiment 2 of the present invention.

If transmission or receipt of data is not generated for a predetermined time, a mobile terminal 100 transmits a predetermined message to a base station 200 to request entry into sleep mode (S201), and the base station 200 that received the request transmits a response message to the request to the mobile terminal 100 to enter the sleep mode (S202).

If transmission of uplink or downlink data is not generated during the first listening window, the mobile terminal 100 increases the subsequent second sleep window by a predetermined ratio (S203). By way of example of predetermined increase ratios, (the first sleep window+the first sleep window*1/n), (the first sleep window+the first sleep window*1/n2) or the first sleep window*n, etc., may be used.

Specifically, the terminal 100 starts counting simultaneously with starting the first listening window and transmits a message requesting that the second sleep window is increased to the base station 200, if transmission or receipt of data is not generated during a predetermined time. To this end, the mobile terminal 100 may include a monitoring device that monitors whether the transmission or the receipt of data is generated during the first listening window for a predetermined time, and a counting device. The base station 200 that receives the second sleep window increase request message transmits the response message thereto to the mobile terminal 100 and increases the first sleep window. The second sleep window increase request message or the response message to the request includes the length information of the increased second sleep window.

If the data transmission is not generated even during the second listening window that is a listening window subsequent to the first listening window, the mobile terminal 100 increases the third sleep window (not shown in the drawing) that is a sleep window subsequent to the second sleep window by a predetermined ratio.

Specifically, the terminal 100 again starts counting simultaneously with starting the second listening window and transmits a message requesting that the third sleep window is increased to the base station 200, if transmission or receipt of data is not generated during a predetermined time. The base station that received the third sleep window increase request message transmits the response message thereto to the mobile terminal 100, and increases the third sleep window.

If the data transmission is not generated even during listening windows subsequent to the second listening window, step S203 is repeated for the sleep windows subsequent to the second sleep window until the sleep mode is terminated. That is, the increased sleep window may be controlled to not exceed the length of the predetermined maximum sleep window.

Also, in Exemplary Embodiment 2, if the increase condition of the sleep window is satisfied, the mobile terminal 100 and the base station 200 may also automatically increase the sleep window according to the policy that is previously determined. In other words, if the increase condition of the sleep window is satisfied, the sleep window is increased under an implied mutual agreement without exchanging separate request and response messages. This will be described in detail.

In the sleep mode, the mobile terminal 100 and the base station 200 start counting simultaneously with starting the first listening window and increase the second sleep window according to the predetermined rule, if the transmission or receipt of data is not generated for a predetermined time. To this end, the mobile terminal 100 and the base station 200 may include a monitoring device that monitors whether the transmission or the receipt of data is generated during the first listening window for a predetermined time and a counting device. The predetermined rule may include the increase ratio of the sleep window. The second sleep window may be increased at a ratio of (the first sleep window+the first sleep window*1/n), (the first sleep window+the first sleep window*1/n2) or the first sleep window*n, etc.

If the data transmission is not generated even during the second listening window that is a listening window subsequent to the first listening window, the mobile terminal 100 and the base station 200 increase the third sleep window that is a sleep window subsequent to the second sleep window according to the predetermined rule.

If the data transmission is not generated even during listening windows subsequent to the second listening window, the increase of the sleep window is repeated for the sleep windows subsequent to the third sleep window until the sleep mode is terminated. Here, the increased sleep window may be controlled to not exceed the length of the predetermined maximum sleep window.

If the length of the predetermined sleep window has expired or another termination reason for the sleep mode is generated, the mobile terminal 100 transmits a message requesting that the sleep mode is cancelled to the base station 200 (S204), and the base station 200 that receives the request transmits the response message thereto (S205) and deviates from the sleep mode.

The increase of the sleep window according to Exemplary Embodiment 2 may be made as the mobile terminal 100 determines whether the sleep window is increased and requests that the sleep window is increased to the base station 200, and to the contrary, it may also be implemented in the manner than the base station 200 determines whether the sleep window is increased by checking whether the transmission or the receipt of data is performed and reports the increase of the sleep window to the mobile terminal 100.

Also, even while the sleep window is increased, the data may arrive through the listening window at a certain moment. In this case, the subsequent sleep window may be restored to the same value of the start sleep window or may maintain the length of the previous sleep window by stopping the increase of the sleep window.

### Exemplary Embodiment 3

Exemplary Embodiment 3 relates to a method to enhance data transmission efficiency by additionally allocating a temporary listening window, if the data transmission is continued during the listening window for a predetermined time. Here, although the expression “the allocation of the temporary listening window” is used, this may be considered to be the same concept as the expansion of the listening window in the related art.

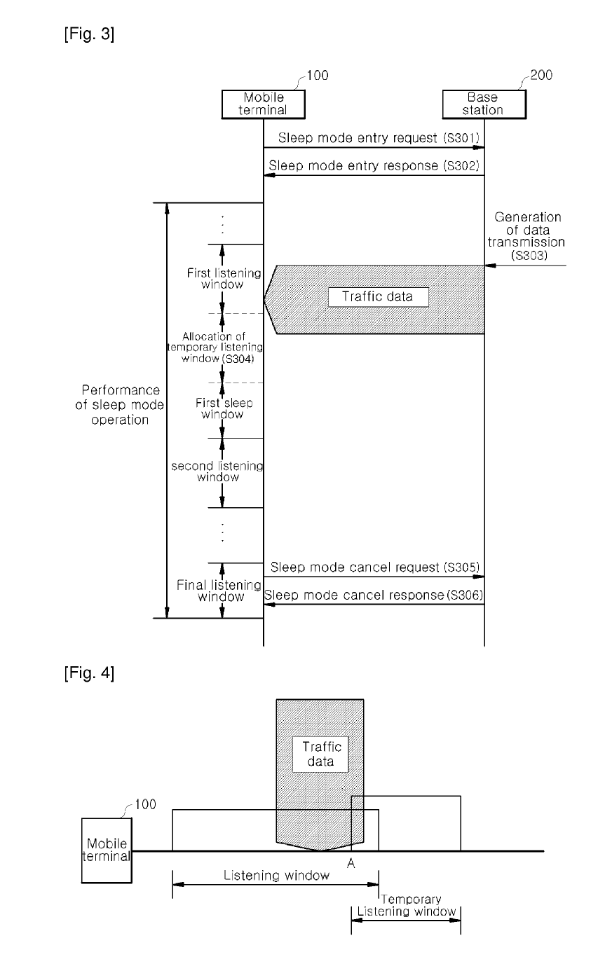

FIG. 3 is a signal flowchart showing an operating method of a sleep mode according to Exemplary Embodiment 3 of the present invention.

If transmission or receipt of data is not generated for a predetermined time, a mobile terminal 100 transmits a predetermined message to a base station 200 to request entry into a sleep mode (S301), and the base station 200 that receives the request transmits a response message to the request to the mobile terminal 100 to enter the sleep mode (S302).

If the transmission of data is maintained during the first listening window for a predetermined time or the transmission of data is continued at a time point preceding the termination time point of the first listening window by a predetermined interval (S303), the mobile terminal 100 requests that the listening window is additionally allocated temporarily to the base station (S304).

Specifically, the mobile terminal 100 starts counting simultaneously with starting the transmission or the receipt of data during the first listening window and transmits a message requesting that the temporary listening window is allocated to the base station 200, if the transmission of data is maintained for a predetermined time or the data transmission is continued at a time point preceding the termination time point of the first listening window by a predetermined interval. To this end, the mobile terminal 100 may include a monitoring device that monitors whether the transmission of data is maintained during the first listening window for a predetermined time or whether the data transmission is continuously maintained at a predetermined time point of the first listening window, and a counting device.

The base station 200 that received the temporary listening window allocation request message transmits the response message to the request to the mobile terminal 100 and allocates the temporary listening window. The temporary listening window allocation request message or the response message to the request may include the length information of the temporary listening window.

The allocation of the temporary listening window may be made as the mobile terminal 100 determines whether the temporary listening window is allocated or requests that the temporary listening window is allocated to the base station 200, and to the contrary, it may also be implemented in the manner that the base station 200 determines whether the temporary listening window is allocated by checking whether the transmission or the receipt of data is performed and reports that the temporary listening window is allocated to the mobile terminal 100.

Also, in Exemplary Embodiment 3, if the allocation condition of the temporary listening window is satisfied, the mobile terminal 100 and the base station 200 may also automatically allocate the temporary listening window according to the policy that is previously determined. In other words, if the allocation condition of the temporary listening window is satisfied, the temporary listening window is allocated under an implied mutual agreement without exchanging separate request and response messages. This will be described in more detail.

In the sleep mode, the mobile terminal 100 and the base station 200 start counting simultaneously with starting the transmission or the receipt of data during the first listening window and allocates the temporary listening window according to a predetermined rule, if the transmission of data is maintained for a predetermined time or the data transmission is continued at a time point preceding the termination time point of the first listening window by a predetermined interval. To this end, the mobile terminal 100 and the base station 200 may include a monitoring device that monitors whether the transmission of data is maintained during the first listening window for a predetermined time or whether the data transmission is continuously maintained at a predetermined time point of the first listening window and a counting device.

Meanwhile, the temporary listening window may be allocated to be started after a predetermined time point within the listening window.

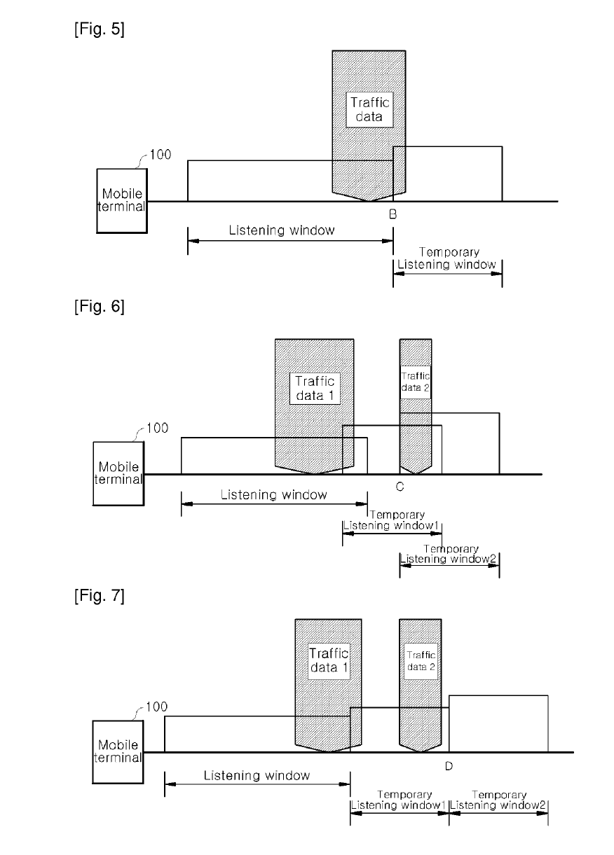

FIGS. 4 and 5 show examples of allocation of a temporary listening window for each type.

In FIG. 4, the data transmission is maintained during the listening window for a predetermined window or the data transmission is continued at a time point preceding the termination time point during the listening window by a predetermined interval so that the temporary listening window is allocated. At this time, the temporary listening window may be allocated to start from time point A preceding the termination time point of the listening window by a predetermined interval.

As shown in FIG. 5, the temporary listening window may be allocated to start at time point B that is the termination time point of the listening window.

Also, if new data transmission is generated during the temporary listening window, the temporary listening window may be additionally allocated from the corresponding generating time point or the termination time point of the temporary listening window. FIGS. 6 and 7 show examples of allocation of an additional temporary listening window for each type.

As shown in FIG. 6, if new data transmission is generated during the temporary listening window, the temporary listening window may be additionally allocated at time point C that is the corresponding generating time point. Also, as shown in FIG. 7, if new data transmission is generated during the temporary listening window, the temporary listening window may also be additionally allocated at time point D that is the termination time point of the previous temporary listening window.

The temporary listening window added in FIGS. 6 and 7 may be allocated to have the identical length of the temporary listening window that is previously allocated, and may also be allocated to have the increased or decreased length at a predetermined ratio.

If the length of the predetermined sleep window is expired or another termination reason for the sleep mode is generated, the mobile terminal 100 transmits a message requesting that the sleep mode is cancelled to the base station 200 (S305), and the base station 200 that receives the request transmits the response message thereto (S306) and deviates from the sleep mode.

Preferably, the temporary listening window of Exemplary Embodiment 3 is allocated to be smaller than or equal to a general listening window or a directly previous listening window.

### Exemplary Embodiment 4

Exemplary Embodiment 4 relates to a method to enhance transmission efficiency of data by allocating a temporary listening window when transmission error control is not completed during a listening window. In the same manner as Exemplary Embodiment 3, although the expression “the allocation of the temporary listening window” is used, this may be considered as the same concept as the expansion of the listening window in the related art.

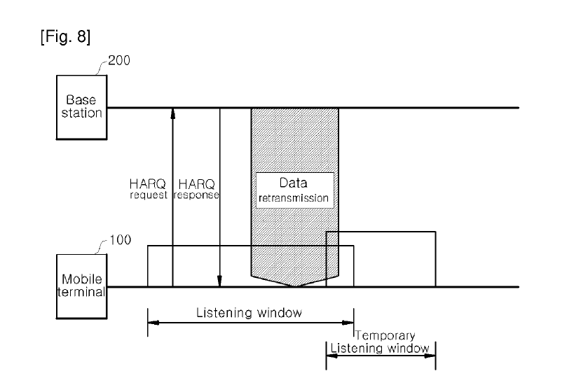

FIG. 8 is a signal flowchart showing an operation method of a sleep mode according to Exemplary Embodiment 4 of the present invention.

As the transmission error control technique that corrects transmission errors through a retransmission request, an automatic repeat request (ARQ), a hybrid automatic repeat request (HARQ), etc., may be used, by way of example. Exemplary Embodiment 4 will be described by exemplifying the HARQ.

If the transmission errors are generated during a process that receives data in the listening window, the mobile terminal 100 attempts to correct errors for the received data through a forward error correction (FEC), etc., and, although the error correction is not solved, the mobile terminal 100 requests that the corresponding data is retransmitted to the base station 200. A NACK message informing that the transmission of the corresponding data is not completed may be used as the message requesting that the corresponding data is retransmitted.

When the request for the retransmission of data is made, after sending the retransmission request message during the listening window, the mobile terminal 100 forecasts that the retransmission of data accordingly thereof is performed to request that the temporary listening window is additionally allocated to the current listening window to the base station 200, as one method to allocate the temporary listening window. A separate request message may be used for the temporary listening window allocation request, and the data retransmission request message may be utilized as the temporary listening window allocation request message.

In the latter case, an explicit method to request the allocation of the temporary listening window using a specific field (or parameter) of the data retransmission request message or an implied method to allow the data retransmission request message itself to be recognized as the request of the temporary listening window allocation may be used.

With the implied method, if the data retransmission request is received from the mobile terminal 100, the base station 200 may additionally allocate the temporary listening window to the current listening window, and may report the added allocation particulars to the mobile terminal 100.

As another method to allocate the temporary listening window, if the data retransmission is maintained or the data transmission is continued at a time point preceding the termination time point of the listening window by a predetermined interval when the data retransmission is performed during the listening window, the mobile terminal 100 may request that the temporary listening window is additionally allocated to the current listening window to the base station 200. To the contrary, the base station 200 may determine whether the temporary listening window is allocated by checking whether the data retransmission is maintained for a predetermined time or whether the data transmission is continued at a time point preceding the termination time point of the listening window by a predetermined interval, and may report the allocation of the temporary listening window to the mobile terminal 100.

As described above, when the allocation of the temporary listening window is required, the temporary listening window receives the allocation or allocates by transmitting the separate request message or the reporting message to the other party. However, under the same circumstance, the mobile terminal 100 and the base station 200 may also automatically allocate the temporary listening window according to the predetermined rule, without the transmission of a separate explicit message.

Meanwhile, the temporary listening window may be additionally allocated or expanded until the data transmission is normally completed without errors.

Also, when the data retransmission is normally completed before the listening window or the temporary listening window is terminated, the mobile terminal 100 may request immediate termination of the listening window to the base station 200. For the termination request of the listening window as described above, a response message (ACK message) of the mobile terminal 100 according to the normal completion of the data retransmission or a separate request message may be used.

Finally, the temporary listening window according to Exemplary Embodiment 4 is preferably allocated to be smaller than or equal to the original listening window.

### Exemplary Embodiment 5

If class 1 for a non-real-time data transmission and class 2 for a real-time data transmission are operated simultaneously, the power saving efficiency of class 1 is likely to be limited by class 2. Exemplary Embodiment 5 relates to a method to minimize power consumption by controlling the power saving modes having services on the assumption that data transmission characteristics are different and are not to be operated simultaneously.

When the mobile terminal or the base station requests a connection to the other party for the transmission of data, the corresponding request message includes the property information of the data transmission. Further, the class of power saving mode is determined according to the data transmission.

As a first example, when the mobile terminal is connected to the first base station for the receipt of data (the first-1 connection), if the data to be received is non-real-time data, the mobile terminal is operated as class 1 of the power saving mode.

While being operated as class 1, if the connection request is received from the second base station (the first-2 connection) and the corresponding connection request is determined as being for the transmission of the real-time data, the mobile terminal selects class 1 rather than class 2 that is for the transmission of the real-time data as the power saving mode. In addition, the selected power saving mode is reported to the second base station.

Here, in the first-2 connection, the parameter of class 1 for the non-real-time data transmission may be used as it is, ignoring the property of the real-time data transmission, and the parameter of class 1 may also be replaced by a partial parameter of class 2 for the real-time data transmission to be used.

For the latter, the mobile terminal requests that the partial parameter of class 1 is replaced by the parameter of class 2, while reporting the changed power saving mode to the second base station. Regarding this, the second base station may transmit a response message permitting the parameter change request to the corresponding mobile terminal.

As a second example, in the second-1 connection between the mobile terminal and the first base station, if the data to be received is the real-time data, the mobile terminal is operated as class 2 of the power saving mode.

While being operated as class 2, if the request for the second-2 connection is received from the second base station and the corresponding connection request is determined as being for the transmission of the non-real-time data, the mobile terminal selects class 2 rather than class 1 as the power saving mode. The selected power saving mode is reported to the second base station.

At this time, in the second-2 connection, the parameter of class 2 may be used as it is, ignoring the property of the non-real-time data transmission, and the parameter of class 2 may also be replaced by the partial parameter of class 1 to be used.

For the latter, the mobile terminal requests that partial the parameter of class 2 is replaced by the parameter of class 1, while reporting the changed power saving mode to the second base station. Regarding this, the second base station may transmit a response message permitting the parameter change request to the corresponding mobile terminal.

As a third example, when the second base station requests the third-2 connection for the transmission of the real-time data to the mobile terminal that is connected to the first base station (the third-1 connection) in the power saving mode of class 1, the second base station may request the mobile terminal to be operated as class 1 rather than class 2 for the third-2 connection, if the mobile terminal reports the sort of class (the first class) of the power saving mode currently operated in response to the request for the third-2 connection.

Here, in the third-2 connection, the parameter of class 1 for the non-real-time data transmission may be used as it is, ignoring the property of the real-time data transmission, and the parameter of class 1 may also be replaced by the partial parameter of class 2 for the real-time data transmission to be used.

For the latter, the second base station requests that the partial parameter of class 1 is replaced by the parameter of class 2, while reporting the sort of class (class 1) of the power saving mode to the mobile terminal. Regarding this, the mobile terminal may transmit a response message permitting the parameter change request to the second base station.

As a fourth example, when the second base station requests the fourth-2 connection for the transmission of the non-real-time data to the mobile terminal that is connected to the first base station (the fourth-1 connection) in the power saving mode of class 2, the second base station may request the mobile terminal to be operated as class 2 rather than class 1 for the fourth-2 connection, if the mobile terminal reports the sort of class (the second class) of the power saving mode currently operated in response to the request for the fourth-2 connection.

In the same manner, in the fourth-2 connection, the parameter of class 2 for the non-real-time data transmission may be used as it is, ignoring the property of the non-real-time data transmission, and the parameter of class 2 may also be replaced by the partial parameter of class 1 for the non-real-time data transmission to be used.

For the latter, the second base station requests that partial parameter of class 2 is replaced by the parameter of class 1, while reporting the sort of class (class 2) of the power saving mode to the mobile terminal. Regarding this, the mobile terminal may transmit a response message permitting the partial parameter replace request to the second base station.

Meanwhile, in Exemplary Embodiment 5 as described above, the first base station and the second base station may be separate base stations or may also be the same base station.

Also, the two connections having different data transmission characteristics may be integrated and be managed by applying the same power saving class thereto, however, although the class applied to each connection is the class (class 1 or class 2) of the same kind, the detailed parameters may also be partially differently operated to meet the characteristics of each connection.

As a fifth example, when the base station is connected to the first mobile terminal for the reception of data (the fifth-1 connection), if the data to be received is the non-real-time data, the mobile terminal is operated as class 1 of the power saving mode.

While being operated as class 1, if the connection request is received from the second mobile terminal (the fifth-2 connection) and the corresponding connection request is determined as being for the transmission of the real-time data, the base station selects class 1 rather than class 2 for the real-time data transmission as the power saving mode. And, the selected power saving mode is reported to the second mobile terminal.

Here, in the fifth-2 connection, the parameter of class 1 for the non-real-time data transmission may be used as it is, ignoring the property of the real-time data transmission, and the parameter of class 1 may also be replaced by partial parameter of class 2 for the real-time data transmission to be used.

### Exemplary Embodiment 6

Exemplary Embodiment 6 relates to a method to terminate a sleep mode even without the transfer of a separate message between a mobile terminal and a base station, if data transmission is generated in the sleep mode at a time point when entering into the sleep mode.

Specifically, if the transmission or the receipt of data is not generated for a predetermined time, the mobile terminal 100 transmits a predetermined message (for example, a sleep mode request message) to the base station 200 to request the entry into the sleep mode. The message may include a parameter (or a field item) that stipulates to automatically cancel the sleep mode therebetween without the transfer of a separate message for the sleep mode cancel request or the sleep mode cancel report, etc., if data transmission traffic is generated in the sleep mode.

The above-mentioned exemplary embodiments of the present invention are not embodied only by a method and apparatus. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A power saving method of a transmitter in a sleep mode, comprising:
monitoring whether data transmission is generated during a listening window; and
decreasing a sleep window subsequent to the listening window if the data transmission is generated during the listening window.

2. The power saving method of the transmitter in the sleep mode of claim 1, further comprising reporting the decrease of the sleep window to a receiver if the data transmission is generated during the listening window.

3. The power saving method of the transmitter in the sleep mode of claim 1, further comprising, before decreasing the sleep window,
requesting the decrease of the sleep window to the receiver.

4. The power saving method of the transmitter in the sleep mode of claim 1, wherein, if the data transmission is generated during the listening window, the receiver and the transmitter automatically decrease the sleep window according to a predetermined rule.

5. A power saving method of a transmitter in a sleep mode, comprising:
monitoring whether data transmission is generated during a listening window; and
increasing a sleep window subsequent to the listening window if the data transmission is not generated during the listening window.

6. The power saving method of the transmitter in the sleep mode of claim 5, further comprising reporting the increase of the sleep window to a receiver if the data transmission is not generated during the listening window.

7. The power saving method of the transmitter in the sleep mode of claim 5, further comprising, before the increasing of the sleep window, requesting the increase of the sleep window to the receiver.

8. The power saving method of the transmitter in the sleep mode of claim 5, wherein, if the data transmission is not generated during the listening window, the receiver and the transmitter automatically increase the sleep window according to a predetermined rule.

9. The power saving method of the transmitter in the sleep mode of claim 8, further comprising, if the data transmission is generated during a listening window subsequent to the listening window, restoring the subsequent sleep window to the length of the start sleep window.

10. A power saving method of a transmitter in a sleep mode, comprising:
confirming whether data transmission is maintained during a listening window for a predetermined interval; and
additionally allocating a temporary listening window if the data transmission is maintained.

11. The power saving method of the transmitter in the sleep mode of claim 10, further comprising reporting an allocation of the temporary listening window to a receiver if the data transmission is maintained during the listening window for a predetermined interval.

12. The power saving method of the transmitter in the sleep mode of claim 10, further comprising, before the allocating of the temporary listening window, requesting the allocation of the temporary listening window to the receiver.

13. The power saving method of the transmitter in the sleep mode of claim 10, wherein, if the data transmission is maintained during the listening window for a predetermined interval, the receiver and the transmitter allocate, without user intervention, the temporary listening window according to a predetermined rule.

14. The power saving method of the transmitter in the sleep mode of claim 13, further comprising, if the data transmission is terminated, requesting an immediate termination of the temporary listening window to the receiver.

15. A power saving method of a receiver in a sleep mode, comprising:
if transmission errors are detected from received data, requesting retransmission of the received data to a transmitter; and
allocating a temporary listening window for the data retransmission.

16. The power saving method of the receiver in the sleep mode of claim 15, further comprising, before the allocating of the temporary listening window, requesting allocation of the temporary listening window to the transmitter.

17. The power saving method of the receiver in the sleep mode of claim 16, wherein the data retransmission and the allocated temporary listening window are requested through a same message.

18. The power saving method of the receiver in the sleep mode of claim 15, further comprising, if the data retransmission is normally terminated, requesting immediate termination of the temporary listening window to the transmitter.

19. A power saving method of a transmitter that is connected to a first receiver and a first power saving class, comprising:
receiving a connection request for data transmission from a second receiver; and
if a second power saving class for the connection with the second receiver is different from the first power saving class, operating as the first power saving class for the second receiver.

20. The power saving method of the receiver in the sleep mode of claim 19, wherein, for the connection with the second receiver, a partial parameter of the first power saving class is replaced by a parameter of the second power saving class to be operated.
